(19) United States
(12) Patent Application Publication
(10) Pub. No.: US 2011/0276651 A1
(43) Pub. Date: Nov. 10, 2011

(54) ROUTING LOGIC

(75) Inventors: Duncan Russell Christopher Charles Edward Sample, Huntingdon (GB); Carlos Manzanares Sancho, Tampere (FI); Konrad Daniel Garlikowski, Wroclaw (PL); Mikhael Harswanto, Jakarta (ID); Irving Benjamin Cordova, Bogota (CO); Caio Bottiglieri, Sao Paulo (BR); Martin Kurt Grundmann, Munich (DE); Prerna Sawhney, New Delhi (IN); Joao Travassos Cabral Martins, Lisboa (PT); Indra Gunawan, Bandung (ID); Tianling Lu, Frisco, TX (US)

(73) Assignee: NOKIA SIEMENS NETWORKS OY, Espoo (FI)

(21) Appl. No.: 12/776,859

(22) Filed: May 10, 2010

(51) Int. Cl. G06F 15/16

(52) U.S. Cl. 709/217

(57) ABSTRACT

The present invention relates to methods and apparatus for controlling communication. An apparatus 102, for example, a routing logic component may receive user control settings relating to a user 103, 105, may receive application control settings relating to an application; and may receive operator control settings relating to an operator 107, 109. Communications between a device 104, 106 of said user 103, 105 and said application 112, 113 and between said application 112, 113 and said operator 107, 109 based on one or more of said user control settings, said application control settings and said operator control settings.

The present invention relates to routing logic and, in particular, to the routing of communications between a user device and an application.

Numerous and various applications are currently provided relating to various aspects such as providing services, games, information, data, and so on. In order for an application to be provided to one or more users then the application has to be trusted by one or more mobile operators and by one or more users.

An operator may wish to only allow those applications it trusts to utilise the operator's assets, e.g. network, and to access the users subscribed to the operator. The operator may be a Customer Service Provider (CSP) with an Information Technology network and/or telecommunication network, a mobile operator with a mobile network, a fixed-line operator with a fixed network, and so on. Therefore, in order to gain the trust of the operator the application may have to be developed for the operator or obtain approval from the operator which may take a substantial amount of time and effort including the need for the application to be developed with knowledge of the operator's domain, e.g. the telecommunication domain if the operator is a mobile operator, or the Information Technology (IT) domain if the operator is a CSP providing IT services. Also, the process of setting a purchase and sale price between the developer and the operator may be difficult, time-consuming and inflexible especially if multiple operators are involved.

The application may be developed for one particular operator and therefore may only utilise the assets of that operator and be provided to only the users subscribed to the operator. The application may be developed for more than one of the available operators, therefore leading to increased difficulty in publishing and providing the application as the developer will have to negotiate individually with each operator.

A user via their device, e.g. mobile device, computing device, etc., may only access or use an application they trust as the user will have to interact with the application in order to cancel or stop receiving communication messages from the application. Therefore, unless the user can trust that they are able to control the application and not receive unwanted communication messages the user may not even try or subscribe to the application.

Therefore, the development of applications may be inhibited by the difficulty to enter the market.

Cloud Computing is a paradigm that moves resources, services and applications into a cloud enabling users to access and utilise the resources, services and applications. The cloud may refer to delivering resources, services and applications over the Internet which are sold/used on demand and provides substantial flexibility.

As such, more and more applications are moving into the cloud and the current model and mechanisms for publishing and providing applications is inflexible and inefficient.

Thus, there is a need to provide a flexible approach to providing applications, in particular in the cloud, enabling the developers of the application, the operators and the users to control and manage the use and implementation of the application. The present invention seeks to address one or more of the needs described hereinabove.

According to a first aspect of the present invention there is provided a method comprising: receiving user control settings relating to a user; receiving application control settings relating to an application; receiving operator control settings relating to an operator; and controlling communications between a device of the user and the application and between the application and the operator based on one or more of the user control settings, the application control settings and the operator control settings.

The method, preferably for operating or providing a routing logic component, receives user control settings, application control settings and operator control settings and controls the communication based on one or more of the user control settings, application control settings and operator control settings. The control settings for each entity (e.g. user, application, and operator) may include any control settings necessary for controlling the communication.

The user control settings may primarily relate to the privacy of the user and to the use of the application by the user. The user control settings may include privacy settings for the user, for example, whether an application can communicate with the user, the information or data relating to the user that the application may access or obtain, and so on. The user control settings may include device settings for the user, for example, the type of the device, the capabilities of the device, the functionality that the application may access on the user device, and so on. The user control settings may include user settings, for example, usernames, passwords, single sign-on settings, and so on so that automatic access to the application may be enabled and which may be used to bind the user to the application.

The application control settings may be provided by a developer of the application, by the provider of the application or by both the developer and the provider. The developer and the provider may be the same entity or different entities. The application control settings may primarily relate to the audience (e.g. the operators, the users, and the user devices) of the application. The application control settings may include, for example, the price of the application depending on the mode of use of the application, the age or location settings for a user to access the application, a quality of service level required from the operators, e.g. bandwidth, availability, etc, which operators may offer for use the application, the necessary functionality or capabilities of the user device to execute or access the application, and so on.

The operator control settings may be provided by each operator and may primarily relate to the use of the operator's assets by the application. The operator control settings may include, for example, whether the application can access or use the operator's assets, e.g. the operator's network, the operator's subscribers, etc, whether the operator has exclusivity to use the application, and so on.

The control settings for each entity (user, application and operator) mentioned hereinabove are possible examples of such control settings that each party may set. As will be appreciated, the control settings may include only a subset of those mentioned or may include any other control settings that may be required to control the communication.

The communication may be controlled based on one or more of the user control settings, application control settings and operator control settings. Depending on the type of the application only one or more of the user control settings, application control settings and operator control settings may be necessary in order to control the communication.

The device of the user may be a mobile device, e.g. a mobile telephone, or may be a computing device, e.g. a personal computer, laptop, etc. The device of the user includes the functionality or capability to transmit and/or receive information or data over a network.

The operator may be a mobile operator, Customer Service Provider (CSP), fixed operator, and so on. The operator may therefore be any entity that may offer applications to its users.

The application may include any application that may be developed including applications that are developed for or published in the so-called cloud. As will be appreciated, there are many applications available and being developed that cover many varying aspects including, for example, providing information, games, social interactions, and so on.

The user control settings, application control settings and operator control settings may be set or provided at any time by the relevant entity. The user control settings, application control settings and operator control settings may be modified or updated at any time thereby enabling a flexible control of the communication.

The control settings of one entity may be dependent or based on the control settings of another entity. For example, based on the price, quality of service required set in the application control settings may affect the operator control settings from one or more operators as the operator may not wish to pay the price or be able to fulfil the requested quality of service.

The control of the communication may be based on rules or bindings between the control settings set by one or more of the user, application and operator.

The method may be implemented in the so-called cloud of cloud computing, may be implemented in the telecommunication domain, may be implemented as a separate apparatus such as a computing device, server, etc, or may be implemented as part of an existing element or device in a network.

The step of controlling communications may further comprise determining if the communications are enabled or disabled based on one or more of a first relevant part of the user control settings, a first relevant part of the application control settings and a first relevant part of the operator control settings. To control the communication the method may determine if the communications are enabled or disabled based on one or more of the first relevant parts of the user control settings, application control settings and operator control settings. The user control settings, application control settings and operator control settings may include several control settings but only one or more of those control settings may be necessary to determine whether communication is enabled or disabled. Thus, the first relevant parts of the user control settings, application control settings and operator control settings are the control settings that are necessary for making the determination as to whether the communication is enabled or disabled.

The step of determining if communications are enabled or disabled may be based on an aggregation of the one or more of the first relevant part of the user control settings, the first relevant part of the application control settings and the first relevant part of the operator control settings. In order to determine whether the communication is enabled or disabled the method may aggregate the one or more first relevant parts of the user control settings, application control settings and operator control settings. In other words, if any one of the one or more first relevant parts of the user control settings, application control settings and operator control settings specify or indicate that the communication is disabled then the communication may be determined as disabled.

The step of controlling communications may further comprise determining routing information for the communications based on one or more of a second relevant part of the user control settings, a second relevant part of the application control settings and a second relevant part of the operator control settings. To control the communication the method may determine routing information based on one or more of the second relevant parts of the user control settings, application control settings and operator control settings. The user control settings, application control settings and operator control settings may include several control settings but only one or more of those control settings may be necessary to determine routing information. Thus, the second relevant parts of the user control settings, application control settings and operator control settings are the control settings that are necessary for making the determination of the routing information for the communication. The routing information may include an indication of the route or path that the communication may be transmitted based on the second relevant control settings. For example, if the cheapest route is requested for the communication then the routing information may determine from the second relevant operator control settings the cheapest route for the communication and use the determination as the routing information. If a particular quality of service level is requested then the determination of the routing information may determine the optimum route for the communication that provides the requested level of service. If one operator has exclusivity of the application then the routing information determined may indicate that the communication has to be routed via only the operator's assets, e.g. the operator's network.

The step of determining routing information for the communications is based on an aggregation of the one or more of the second relevant part of the user control settings, the second relevant part of the application control settings and the second relevant part of the operator control settings. In order to determine routing information the method may aggregate the one or more second relevant parts of the user control settings, application control settings and operator control settings. In other words, based on the combination or aggregation of the one or more relevant second parts of the control settings the optimum routing information for the communication may be determined.

The routing information may be based on one or more of the relevant second parts of the user control setting, application control settings, and operator control settings as only one or more of those control settings may be necessary on order to determine the routing information for the communication.

The step of determining routing information is dependent on the communications being determined as enabled. The steps of determining whether the communication is enabled or disabled may be performed either before or after determining routing information for the communication.

The method may further comprise receiving a request to publish the application and in response to the request to publish transmitting a request for one or more of user control settings, operator control settings and application control settings. An application may be published, in other words made active or offered for use, by a developer and/or a provider of the application by transmitting a request to publish the application. The request to publish may or may not receive application control settings. If the request to publish does not include the application control settings then the method may request the application control settings. If the user control settings from one or more users and/or the operator control settings from one or more operators is necessary then the method may request the corresponding control settings from those parties.

If control settings are not received from any of the parties then a default standard set of control settings may be set by the method. The user control settings and/or operator control settings may be received at any time, e.g. when the application is published, when the user first accesses or uses the application, when the operator first uses or offers for use to its subscribers, and so on.

The received user control settings, application control settings and operator control settings may be stored by the method. The user control settings, application control settings and operator control settings may be stored on a per application basis thereby binding the control settings for each application with the particular application. Thus, when a user requests access or uses an application then the control settings for the user, the application and the operators are binded together and the determinations for controlling the communication can be made.

The method may further comprise initiating transmission of the communication based on the determination as to whether the communication is enabled and based on the determination of the routing information.

For communication between a user and an application the method may determine from the communication an identifier of the user and an identifier of the application which may be used to locate or retrieve the relevant control settings for controlling the communication as the identifiers bind the user and the application.

According to a second aspect of the present invention there is provided an apparatus comprising: a first input adapted to receive user control settings relating to a user; a second input adapted to receive application control settings relating to an application; a third input adapted to receive operator control settings relating to an operator; and a first processor adapted to control communications between a device of the user and the application and between the application and the operator based on one or more of the user control settings, the application control settings and the operator control settings.

According to a third aspect of the present invention there is provided an apparatus adapted to: receive user control settings relating to a user; receive application control settings relating to an application; receive operator control settings relating to an operator; and control communications between a device of the user and the application and between the application and the operator based on one or more of the user control settings, the application control settings and the operator control settings.

The apparatus may be a computing device, e.g. a server, computer, and so on. The apparatus may be a routing logic component implemented on a computing device. The apparatus may be implemented on an existing network element or computing device. The apparatus may be located in the cloud, in a telecommunication network or in an Information Technology network.

The apparatus may further comprise a second processor adapted to determine if the communications are enabled or disabled based on one or more of a first relevant part of the user control settings, a first relevant part of the application control settings and a first relevant part of the operator control settings on request of the first processor.

The second processor may be adapted to determine if communications are enabled or disabled based on an aggregation of the one or more of the first relevant part of the user control settings, the first relevant part of the application control settings and the first relevant part of the operator control settings.

The apparatus may further comprise a third processor adapted to determine routing information for the communications based on one or more of a second relevant part of the user control settings, a second relevant part of the application control settings and a second relevant part of the operator control settings on request of the first processor.

The third processor may be adapted to determine routing information for the communications based on an aggregation of the one or more of the second relevant part of the user control settings, the second relevant part of the application control settings and the second relevant part of the operator control settings.

The third processor may be requested to determine routing information by the first processor if the second processor determined the communication is enabled.

The apparatus may further comprise a fourth input adapted to receive a request to publish the application; and a first output adapted to transmit a request for one or more of user control settings, operator control settings and application control settings in response to the request to publish the application.

The first processor may be further adapted to initiate transmission of the communication based on the determination of whether communication is enabled and based on the determination of the routing information.

The apparatus may further comprise a storage means adapted to store the received user control settings, application control settings and operator control settings on a storage medium.

The first input, second input, third input and fourth input may be the same input, different inputs or any combination thereof. The first processor, second processor and third processor may be the same processor, different processors or any combination thereof.

As a skilled person in the art will appreciate, the apparatus may be adapted to perform the functions and features of the aspect of the invention in many different ways. For example, the apparatus may be adapted using software, hardware or any combination thereof.

According to a fourth aspect of the present invention there is provided a computer program product comprising computer readable executable code for: receiving user control settings relating to a user; receiving application control settings relating to an application; receiving operator control settings relating to an operator; and controlling communications between a device of the user and the application and between the application and the operator based on one or more of the user control settings, the application control settings and the operator control settings.

The computer program product may further comprise computer readable executable code for determining if the communications are enabled or disabled based on one or more of a first relevant part of the user control settings, a first relevant part of the application control settings and a first relevant part of the operator control settings.

The computer program product may further comprise computer readable executable code for determining routing information for the communications based on one or more of a second relevant part of the user control settings, a second relevant part of the application control settings and a second relevant part of the operator control settings.

The computer program product may further comprise computer readable executable code for performing any or all of the functions or features in accordance with the aspects of the invention.

Embodiments of the present invention will now be described, by way of example only, and with reference to the accompanying drawing in which:

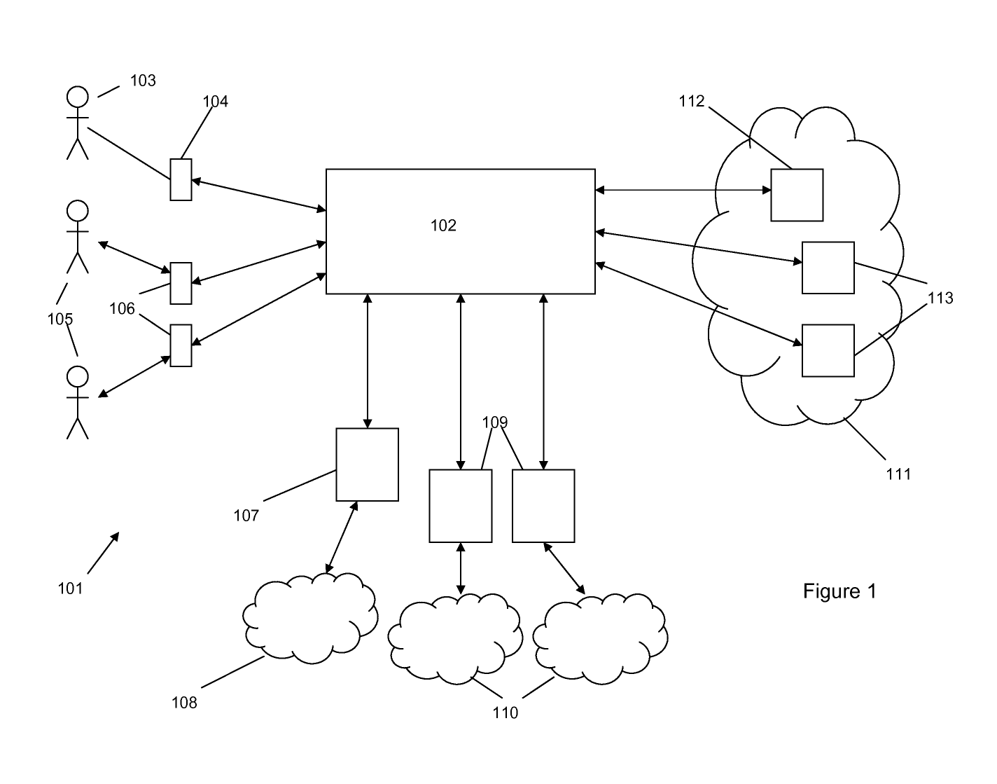

FIG. 1 shows a simplified block diagram of a system in accordance with many of the embodiments of the present invention.

With reference to FIG. 1, a system 101 is shown which comprises a routing logic component 102 that is operatively connected to devices 104, 106, operators 107, 109 and applications 112, 113.

The routing logic component 102 may be implemented on a computing device, for example, a gateway, server, and so on, or the routing logic component 102 may be implemented as functionality on a component of the telecommunication network, for example, a network element, management system, and so on. The routing logic component 102 may be implemented on or located in the cloud enabling the routing logic component 102 to be offered as a service, resource or platform.

The devices 104, 106, e.g. mobile devices, are used by users 103, 105 to enable the user 103, 105 to transmit and receive data across a network, e.g. a telecommunication network which may include mobile network infrastructure and/or fixed network infrastructure along with associated management systems. The detail of the network is not described or shown in FIG. 1 as this would be known and understood by a person skilled in the art.

Each user 103, 105 may have a subscription with an operator 107, 109, e.g. a mobile operator, so that the user 103, 105 via their device 104, 106 can utilise the operator's network 108, 110 in order to transmit and receive data.

Applications 112, 113 are published in the cloud 111 where a published application 112, 113 is one that is active and made available so it can be accessed or used by a user 103, 105 via their device 104, 106. The applications 112, 113 are developed by a developer and provided by a provider where the developer and the provider may be the same entity or different entities. For the purpose of this description of the embodiments it is assumed that the developer will also be the entity that provides the application for use.

The applications 112, 113 may cover any aspect, for example, to provide information, to provide location based services, to provide games, to provide tools (e.g. office tools, financial tools, social tools, and so on). As will be appreciated the applications 112, 113 may be directed or relate to any aspect or functionality that may be used by a user 103, 105.

A developer may develop an application 112 and publish the application 112 in the cloud 111. In order to publish the application 112 in the cloud the developer may register it with the routing logic component 102 and supply application control settings for the application. The developer may register the application 112 and provide the application control settings via a computing device, for example, a personal computer, a laptop, and so on.

The application control settings for the application 112, 113 may include various settings that the developer attaches to their application 112, 113. For example, the application control settings may include settings relating to the operator 107, 109, may include settings relating to the user 103, 105, may include settings relating to the device 104, 106, and so on. As will be appreciated, there are numerous application control settings that a developer may assign to their application on registering and/or publishing the application 112 at the routing component 102.

Examples of settings relating to a user 103,105 may include specifying an age limit or age range of the user 103, 105 that is allowed to access or use the application, the location of the user 103, 105, and so on.

Examples of settings relating to a device 104, 106 may include the type of device that can support or execute the application, the functionality required on the device (e.g. a Global Positioning System (GPS) receiver, a camera, etc.), and so on.

Examples of settings relating to a mobile operator 107, 109 may include the price of the application (which may include different prices if the application is used by multiple operators 107, 109, is reserved by a operator 107 for use by only the operator, etc.), may include effectively service level agreement settings (e.g. may specify the minimum bandwidth to be used for the application, quality of service, availability etc.), may prevent the application 112, 113 from using one operators assets if another operator has exclusivity for the application 112, 113 and so on.

The application control settings specified by the developer may be changed at any time by the developer and therefore the routing logic component 102 enables a flexible way to manage and control the use of the application by the developer without needing to negotiate with operators 107, 109 or to monitor the usage of users 103, 105 to prevent those which the developer does not want to access the application 112, 113.

The routing logic component 102 may also receive user control settings for the application 112, 113 for the first time either when the application 112, 113 is published in the cloud 111 or when the user 103 first accesses or uses the application 112, 113. The user 103 may use their device 104 to transmit their user control settings for the application 112, 113 to the routing logic component 102 where the device may be a mobile device or a computing device such as a personal computer, a laptop, and so on. The user control settings may include settings to block the application 112, 113, restrict the use of the functionality on the device 104 of the user 103 by the application 112, 113, restrict the information or data about the user 103 or their device 104 that the application 112, 113 can access, and so on.

The user 103 may alter the user control settings for the application 112, 113 at any time to enable the user 103 to control and manage the access to the application 112, 113. For example, after a period of time of using the application 112, 113 the user 103 may, via the user control settings, block the application 112, 113 from transmitting communication messages to the device 104 of the user 103.

As will be appreciated, there are numerous user control settings that a user 103 may set relating to the access and use of the application 112, 113.

The routing logic component 102 may further receive operator control settings for the application 112 from each of the operators 107, 109. The operators 107, 109 may supply their operator control settings when the application 112, 113 is published or registered with the routing logic component 102.

The operator control settings may enable each operator to manage and control the access to the operator's 107, 109 assets, for example, the operator's network 108, 110, the operator's subscribers, and so on.

The operator control settings may also be used by one operator to obtain exclusivity of the application 112, 113, may be used to allow the application 112, 113 to utilise the operator's network 108, 110, may be used to allow the application 112, 113 to communicate with the operator's subscribers, and so on.

As will be appreciated, there are numerous operator control settings that a operator 107, 109 may set relating to the access the application 112, 113 has to the assets of the operator 107, 109.

The operator control settings of an operator 107, 109 may be dependent or based on the application control settings. For example, the operator 107, 109 may not agree with the application control settings relating to the price of the application 112, 113 and therefore disable or prevent the use of the application 112, 113 by the user's 103, 105 that are subscribed to the operator 107, 109 or disable or prevent the application 112 from utilising the assets of the operator 107, 109. The operator control settings may be dependent on other operator's operator control settings. For example, if one operator 107 has exclusivity for the application 112 to use that operator's 107 assets then other operator s 109 may set or have set their operator control settings to prevent or disable the application 112 from using their assets.

In the case that the routing logic component 102 does not receive control settings from one or more operator s 107, 109 or one or more users 103, 105 then the routing logic component 102 may, in this case, set as default in the user control settings for the user or in the operator control settings of the operator that the application is prevented or disabled from accessing the assets of the operator 107, 109 and from communicating with the user 103, 105.

Accordingly, the routing logic component 102 enables the application 112, 113 to be published or made available to operators 107, 109 and to user's 103, 105 where the users, operators and developers can provide their respective control settings. Thus, the routing logic component provides a flexible mechanism for providing, managing and controlling applications without all parties having to negotiate either before or after the application 112 is developed. The routing logic component 102 also provides each of the parties (e.g. the user, the developer and the operator) the confidence that the use and routing of communication messages therebetween will be controlled according to the control settings that each party has supplied to the routing logic component 102.

The routing logic component 102 may therefore maintain control settings from the developer, from each of the users 103 and from each of the operators 107, 109 for each application 112, 113.

Examples will now be described where the device 104 is a mobile device, e.g. a mobile telephone, of a user 103 and the operators 107, 109 are mobile operators with assets including mobile networks 108, 110. However, as will be appreciated these examples also relate to other devices and other types of operator.

When a user 103, via their mobile device 104, transmits a communication message to the application 112 or the application 112 transmits a communication message to the mobile device 104 of the user 103 then the routing logic component 102 may receive the communication message and control the communication therebetween.

Similarly, if the application 112 transmits a message to one or more of the mobile operators 107, 109 in order to request information or data relating to a user 103 (e.g. age, location, preferences, and so on) then the routing logic component 102 may receive the request message and control the communication therebetween including any response message from the one or more mobile operators 107, 109.

The routing logic component 102 may aggregate one or more of the relevant user control settings, the relevant operator control settings and the relevant application control settings in order to determine whether communication between the mobile device 104 and the application 112 is enabled or disabled.

For example, if the relevant user control settings includes a setting that disables communication to or from the application 112 then the communication between the mobile device 104 of the user 103 and the application 112 may be disabled by the routing logic component 102. If the user control settings do not disable communication but the user 103 is subscribed to a mobile operator 107 that, via the relevant part of their operator control settings, has disabled the use of the mobile operator's assets, including their subscribers, then the communication may be disabled by the routing logic component 102. If the relevant part of the application control settings disable communication to mobile devices 104 of users 103 that are, for example, under the age of 18 and if the user 103 is under the age of 18 then the communication may be disabled by the routing logic component 102.

If the application 112 is requesting information or data from one or more of the mobile operators 107, 109 then if the user control settings specify that information regarding the user 103 should not be provided (e.g. disabled) or the operator control settings of any one of the mobile operators 107, 109 disable access to their assets or information regarding users 103, 105 then the communication between the application 112 and one or more of the mobile operators 107, 109 may be disabled.

As will be appreciated, the relevant parts of the user control settings, operator control settings and the application control settings may relate or include any control settings that define whether communication between the mobile device 104 of the user 103 and the application 112 is enabled or disabled. The routing logic component 102 may aggregate all of the relevant control settings in order to determine or identify whether communications between the mobile device 104 of the user 103 and the application 112 is enabled or disabled. The aggregation of the relevant control settings of one or more of the user control settings, the application control settings and the operator control settings, means that if one or more of the relevant parts of the control settings disable the communication then the communication will be disabled.

If the routing logic component 102 determines that communication is enabled between the mobile device 104 and the application 112, or one or more of the mobile operators 107, 109 and the application 112, then the routing logic component may identify or determine routing information for the communication based on the aggregation of one or more of the relevant user control settings, the relevant application control settings and the relevant operator control settings.

For example, if the relevant user control settings specify that the user 103 wishes to utilise the cheapest method of communication then the routing logic component 102 may identify the mobile operators 107, 109 that allow communication from or to the application 112 using their assets, e.g. the mobile operator's networks 108, 110 which offer the cheapest rates or prices. Based on the identified mobile operators 107, 109 and, if applicable, their relevant operator control settings, the routing logic component 102 may identify or determine the cheapest and optimum route for the communication.

In another example, one mobile operator 107 may, via their operator control settings, specify exclusive use of the application 112 (e.g. a walled garden mode or a closed market mode) then the routing logic component 102 may identify or determine that the communication has to be routed via only the mobile operator 107 that has exclusivity to the application 112.

In another example, one mobile operator 107 may obtain exclusivity for an application 112. However, the mobile operator 107 may re-sell or enable other mobile operators 109 to use or offer the application 112 to their user's 105 where the other mobile operators 109 may be allowed to re-brand the application 112 as their own. The mobile operator 107 that owns the rights to the application 112 may allow the other mobile operators 109 to use their own assets, e.g. mobile networks 110, or be restricted to using the assets, e.g. mobile network 108, of the mobile operator 107 (which owns the rights). The routing logic component 102 may use the relevant part of the control settings in order to determine in each case the optimum routing information for the communication.

In a further example, the developer may specify in the application control settings for the application 112 effectively a service level agreement for the use of the application 112. For example, the developer may specify in the application control settings that a particular quality of service, availability or bandwidth is required. Thus, the routing logic component 102 may identify the mobile operators 107, 109 that are able to provide the specified level of service and determine the routing information accordingly.

As will be appreciated, the routing information determined or identified by the routing logic component 102 may be based on any aggregation of one or more of the relevant settings in the user control settings, application control setting and the operator control settings. The relevant control settings are any such control settings (defined for one or more of the user, the application, and the mobile operators) that may affect the routing of the communication between users 103, 105 and the applications 112, 113.

Based on the identified or determined routing information the routing logic component 102 may initiate the transmission of the communication message between the mobile device 104 and the application 112. For example, the routing logic component 102 may transmit the communication message via the identified one or more mobile operator's network 108, 110.

Accordingly, in many of the embodiments of the present invention there is provided a routing logic component which enables a flexible mechanism to manage and control communication between devices of users and applications, in particular, applications published in the cloud. The routing logic component considers one or more of the control settings set by developers, users and operators in order to determine if communication is enabled between an application and a user. If communication is enabled then the routing logic component may determine the optimum routing information for communication between an application and a user based on one or more of the control settings set by developers, users and operators.

Each of the control settings may be altered or amended at any time thereby enabling a flexible and efficient mechanism for managing the communication between a user and an application. The routing logic component may maintain the various control settings per application.

The routing logic component also enables an efficient and effective mechanism for enabling various modes of providing applications. For example, open markets, where an application may be used by any user and utilise the assets of all operators, fenced markets where an application may only be able to utilise some of the operators' assets, and closed markets where an application may only utilise one operator's assets.

The application control settings set by the developer may be used to control the audience of the application. The user control settings set by a user may be used to control the privacy for the user for the application. The operator control settings set by the operator may be used to control the use of their assets. The control settings for each party may be amended or altered at any time. Also the control settings of one party may depend on the control settings of another party. For example, the developer may specify a particular price for their application and an operator may set the relevant operator control settings to control access to their assets may depend on the requested price and therefore depend on the application control settings. In another example, a first operator may, via their operator control settings, obtain exclusive use of an application and therefore the operator control settings of other operator may be set to disable access to their assets by the application based on either the first mobile operator's operator control settings or on the application control settings which may also specify which operators are enabled to access the application.

The control settings of each party (e.g. user, developer, and operator) may contain any control settings deemed necessary to enable the effective and efficient control for the party. The aggregation of one or more of the relevant control settings of each party for determining whether the communication is enabled or determining routing information means the aggregation of the control settings that are relevant to, or may affect, the determination being made by the routing logic component.

While preferred embodiments of the invention have been shown and described, it will be understood that such embodiments are described by way of example only. Numerous variations, changes and substitutions will occur to those skilled in the art without departing from the scope of the present invention as defined by the appended claims. Accordingly, it is intended that the following claims cover all such variations or equivalents as fall within the spirit and the scope of the invention.

1. A method comprising:
receiving user control settings relating to a user;
receiving application control settings relating to an application;
receiving operator control settings relating to an operator; and
controlling communications between a device of said user and said application and between said application and said operator based on one or more of said user control settings, said application control settings and said operator control settings.

2. The method as claimed in claim 1 in which said step of controlling communications further comprises:
determining if said communications are enabled or disabled based on one or more of a first relevant part of said user control settings, a first relevant part of said application control settings and a first relevant part of said operator control settings.

3. The method as claimed in claim 2 in which said step of determining if communications are enabled or disabled is based on an aggregation of said one or more of said first relevant part of said user control settings, said first relevant part of said application control settings and said first relevant part of said operator control settings.

4. The method as claimed in claim 1 in which said step of controlling communications further comprises:
determining routing information for said communications based on one or more of a second relevant part of said user control settings, a second relevant part of said application control settings and a second relevant part of said operator control settings.

5. The method as claimed in claim 4 in which said step of determining routing information for said communications is based on an aggregation of said one or more of said second relevant part of said user control settings, said second relevant part of said application control settings and said second relevant part of said operator control settings.

6. The method as claimed in claim 4 in which said step of determining routing information is dependent on said communications being determined as enabled.

7. The method as claimed in claim 1 further comprising:
receiving a request to publish said application and in response to said request to publish transmitting a request for one or more of user control settings, operator control settings and application control settings.

8. An apparatus comprising:
a first input adapted to receive user control settings relating to a user;
a second input adapted to receive application control settings relating to an application;
a third input adapted to receive operator control settings relating to an operator; and
a first processor adapted to control communications between a device of said user and said application and between said application and said operator based on one or more of said user control settings, said application control settings and said operator control settings.

9. The apparatus as claimed in claim 8 further comprising:
a second processor adapted to determine if said communications are enabled or disabled based on one or more of a first relevant part of said user control settings, a first relevant part of said application control settings and a first relevant part of said operator control settings on request of said first processor.

10. The apparatus as claimed in claim 9 in which said second processor is adapted to determine if communications are enabled or disabled based on an aggregation of said one or more of said first relevant part of said user control settings, said first relevant part of said application control settings and said first relevant part of said operator control settings.

11. The apparatus as claimed in claim 8 further comprising:
a third processor adapted to determine routing information for said communications based on one or more of a second relevant part of said user control settings, a second relevant part of said application control settings and a second relevant part of said operator control settings on request of said first processor.

12. The apparatus as claimed in claim 11 in which said third processor is adapted to determine routing information for said communications based on an aggregation of said one or more of said second relevant part of said user control settings, said second relevant part of said application control settings and said second relevant part of said operator control settings.

13. The apparatus as claimed in claim 11 in which said third processor is requested to determine routing information by said first processor if said second processor determined said communication is enabled.

14. The apparatus as claimed in claim 8 further comprising:
a fourth input adapted to receive a request to publish said application; and
a first output adapted to transmit a request for one or more of user control settings, operator control settings and application control settings in response to said request to publish said application.

15. A computer program product comprising computer readable executable code for:
receiving user control settings relating to a user;
receiving application control settings relating to an application;
receiving operator control settings relating to an operator; and
controlling communications between a device of said user and said application and between said application and said operator based on one or more of said user control settings, said application control settings and said operator control settings.

16. The computer program product as claimed in claim 15 further comprising computer readable executable code for:
determining if said communications are enabled or disabled based on one or more of a first relevant part of said user control settings, a first relevant part of said application control settings and a first relevant part of said operator control settings.

17. The computer program product as claimed in claim 15 further comprising computer readable executable code for:
determining routing information for said communications based on one or more of a second relevant part of said user control settings, a second relevant part of said application control settings and a second relevant part of said operator control settings.
